(19) United States
(12) Patent Application Publication
(10) Pub. No.: US 2011/0078984 A1
(43) Pub. Date: Apr. 7, 2011

(54) Saddle Pad Facilitating Freedom of Motion of Horse's Shoulders

(76) Inventor: Aberaham Gonzales, Kurtistown, HI (US)

(21) Appl. No.: 12/573,558

(22) Filed: Oct. 5, 2009

(51) Int. Cl. B68C 1/12

(52) U.S. Cl. 54/66

(57) ABSTRACT

An improved saddle pad placed between the saddle and a horse that facilitates unrestricted movement of the horse's forelimbs when the horse is in motion. The improved pad has an underside that demonstrates elevated aspects or voids that correspond to and overlay the horse's shoulder blade area. According to a preferred embodiment, the improved saddle pad has a further elevated aspect running from front to back down the center of said pad that overlays and relieves pressure to the horse's spine. The improved saddle pad may be comprised of a top and bottom layer with the elevated aspects comprising cutouts and channels formed in the bottom layer. The top layer of the saddle pad is fabricated from a breathable fabric such as felt, and the bottom layer, which may be lined on its underside with breathable fabric for comfort to the horse, is fabricated from a shock absorbent material. The improved saddle pad cushions the weight and pressure of the saddle and rider on the horse's back while at the same time facilitating the unrestricted full range of motion of the horse's forelimbs, shoulder blades and related musculature when the horse is in motion as if the horse where unsaddled or being ridden bareback.

### FIELD OF THE INVENTION

This invention describes a novel saddle pad. More specifically, the invention describes a saddle pad specially configured to allow a horse under saddle increased range of motion of the shoulders and forelimbs and to relieve restriction and pressure to the horse's shoulders while in motion.

### BACKGROUND

The natural movement of the unsaddled horse is that the horse's shoulder blade and elbow freely rotate in connection with the horse's strides. The physiology of the horse is such that the underside of the shoulder blade or scapula is attached to the humerus which is attached to the radius. The ulna or elbow is fused to the proximal end of the radius, while the distal end of the radius is part of the knee joint. In forward motion, the horse's knee and lower forelimb move forward, the ulna rotates down, and the scapula rotates back and down. When the unsaddled horse is in motion, the concussive force of the horse's front hooves striking the ground is distributed and absorbed along the length of the forelimbs and the corresponding skeletal and muscular structure, including the scapula and the attached musculature.

A problem arises, however, when a horse is placed under load and the natural fluid motion of the horse's forelimbs is restricted. The general practice is to place a saddle on top of a blanket or other saddle pad which has been laid across a horse's back. The saddle is then cinched down tight through the horse's girth area. The positioning and pressure of the saddle with conventional saddle pad limits the range of motion of the horse's forelimbs, and the horse can no longer move with a natural and comfortable stride.

Horses under saddle tend to stumble, take shorter strides, and loose fluidity of forward motion compared to the unsaddled horse. The restriction placed on the movement of the horse's shoulder by the saddle and pad can result in front leg injury and lameness. Such injury is believed to be caused by the unnatural distribution of the jarring force of the horse's front hoof striking the ground, which becomes focused on the lower portion of the horse's forelimbs due to the restrictive nature of the traditional saddle and saddle pad on the forelimbs' range of motion.

Prior saddle pad improvements have attempted to address the pressure from the weight of the saddle and rider by adding cushioning to the saddle pad at the horse's pressure points, such as over the spine and withers, in an effort to dissipate the pressure on these points. Currently available saddle pads are not designed to and do not address the problem of the saddle and pad restricting the range of motion of the shoulder blade and related musculature when the horse under saddle walks, canters and gallops.

A primary object of the present invention is to provide a saddle pad which cushions and distributes the weight and pressure of the saddle and rider while at the same time facilitating the unrestricted range of motion of the shoulder blade and related horse musculature when the horse is in motion.

### SUMMARY OF THE INVENTION

These and other problems are solved by the subject invention. A unique saddle pad distributes the weight of the rider and saddle over the back of a horse or other animal under saddle. Rather than adding material to the saddle pad to cushion, the present invention removes material from the saddle pad leaving cutouts, voids, raised or elevated aspects, cavities and/or recessed areas within the saddle pad. This novel pad design serves to free up the horse's shoulder joint under saddle enabling the animal's foreleg to move through its full range of motion while also reducing pressure caused by the saddle at certain points on the horse's back, shoulders, and spinal area. The free, unrestricted movement of the horse's shoulders and forelimbs increases the comfort of a horse under saddle and preserves the normal shock absorbing characteristics of the horse's physiology by allowing shocks originating at the hooves to be distributed along the full length of the forelimbs and absorbed more safely and efficiently by the horse's body mass, resulting in fewer injuries to and increased performance and endurance of the horse.

The saddle pad can be constructed of one or more layers. Voids or cutouts are formed in the underside of the saddle pad, being the side that contacts the horse's back, of an appropriate depth to accommodate the horse's shoulders. The voids or cutouts are positioned over the horse's shoulder area such that the horse's shoulders can comfortably extend into the cavity created by the voids. The depth of the voids or cutouts is less than or equal to the thickness of the saddle pad. Otherwise stated, the cutouts may go partially or completely through the saddle pad.

In a preferred embodiment, the saddle pad is made of two layers: a top layer that contacts the horse's saddle and a bottom layer that contacts the horse.

The top layer is of substantially the same shape and size as traditional saddle pads. In a Western saddle embodiment, that shape is rectangular. In an English saddle embodiment, the rearward aspect of the pad is narrow relative to the forward aspect. In a preferred embodiment, the upper layer may be comprised of a breathable fabric material such as felt.

The bottom layer is of substantially the same overall dimension as the top layer and may be made of a shock absorbing material such as rubber. According to a preferred embodiment, the bottom layer is comprised of two separate pieces, a left and right side, the left side being the mirror image of the right side. When the pad is placed on the horse, the left side of the bottom layer drapes over the left side of the horse and the right side of the bottom layer drapes over the right side of the horse.

The left and right side bottom layer pieces are separated a certain distance one from the other and are positioned to leave an elongated narrow channel that corresponds to and runs the length of the horse's spinal column. The relative positioning of the left and right side bottom layer pieces one to the other and to the top layer is fixed by adhering the left and right side bottom layer pieces to the top layer.

A liner such as felt or other fabric may be adhered to the bottom side of the inner layer to provide comfort to the horse by dissipating heat and wicking moisture away from the horse's body. The liner is molded and conforms to the recesses or voids in the bottom layer of the pad created by the shoulder blade cut-outs and by the separation or channel left between the left and right bottom side pieces.

The top layer, bottom layer, and liner, if any, are bonded together to provide durability, longevity, and ease of use. In a preferred embodiment the layers and liner are both glued and stitched together.

By this construction, the saddle pad and saddle sits on the horse's back without pressing down upon the spine and shoulder blade areas. The weight of the saddle and rider above the spinal column and shoulder blades is distributed by the improved saddle pad to other aspects of the horse's back. This relieves pressure to the horse's spine, and the saddle and pad do not press on or restrict the horse's shoulder area at the position of the cutouts, allowing the horse's shoulders to rotate in an unrestricted and unobstructed fashion when the horse is in motion.

### BRIEF DESCRIPTION OF THE DRAWINGS

FIG. 1 is a right side view of a horse under saddle with saddle pad, illustrating the shoulder cutout of the improved saddle pad of the subject invention relative to the horse's shoulder blade area.

FIG. 2A is a top plan view of a Western saddle embodiment of the improved saddle pad of the present invention.

FIG. 2B is a top plan view of an English saddle embodiment of the improved saddle pad of the present invention.

FIG. 3 is a front view section taken along lines 3-3 of FIG. 2A depicting the layered design of the improved saddle pad at the position of the cutouts.

FIG. 4 is an exploded, isometric view of the saddle pad of the present invention in draped position, as if on the back of a horse.

FIGS. 5A through 5C illustrate the horse's musculoskeletal structure, including the scapula, ulna, and radius of the forelimb and the positioning of the bones of the forelimb throughout the forelimb's range of motion.

FIG. 6 illustrates the musculature of a horse's forelimb in relation to the improved saddle pad of the present invention.

### DETAILED DESCRIPTION OF THE PREFERRED EMBODIMENTS

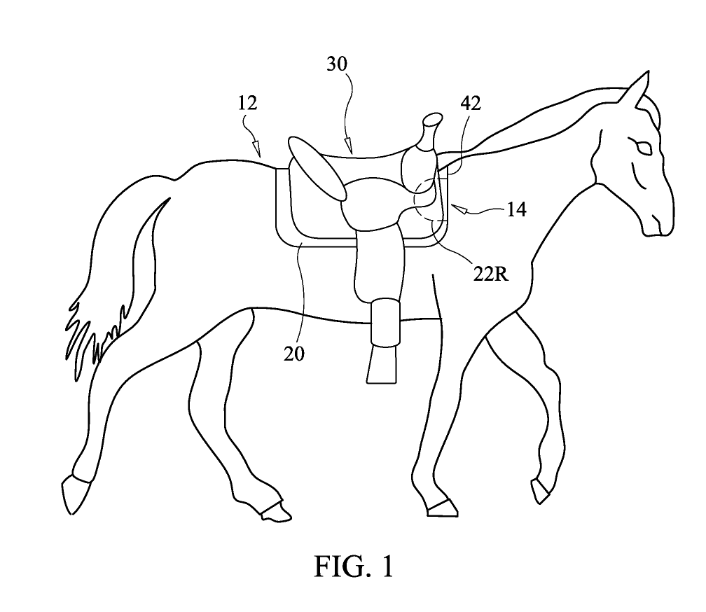

FIG. 1 shows a saddle pad 20 of the present invention in use, placed between a saddle 30 and a horse's back 12. A right side shoulder cutouts 22R formed in saddle pad 20 and lying beneath saddle 30, is depicted with broken lines in FIG. 1. Cutout 22R is of an appropriate depth to accommodate a horse's shoulder area 14. Cutouts 22 are positioned over shoulder area 14 such that the horse's shoulders can protrude into the cavity created by cutouts 22 and avoid contacting or being restricted by saddle 30 or pad 20.

The depth of cutouts 22 is less than or equal to the thickness of saddle pad 20. Otherwise stated, cutouts 22 may go partially or completely through saddle pad 20. Alternately, the void created by cutouts 22 may leave a certain thickness on the topside of pad 20 remaining at the cutout area, forming a cavity or recessed area on the underside of pad 20 that corresponds to and overlays shoulder area 14.

Cutouts 22 in pad 20 are of a certain size and depth to accommodate the horse's natural range of motion by allowing free movement of the horse's forelimbs and the bones and musculature in the horse's shoulder region 14. The cavity created within pad 20 by cutouts 22 reduces or eliminates the weight and restriction on horse's shoulder areas 14 caused by the downward pressure of saddle 30 placed on horse's back 12.

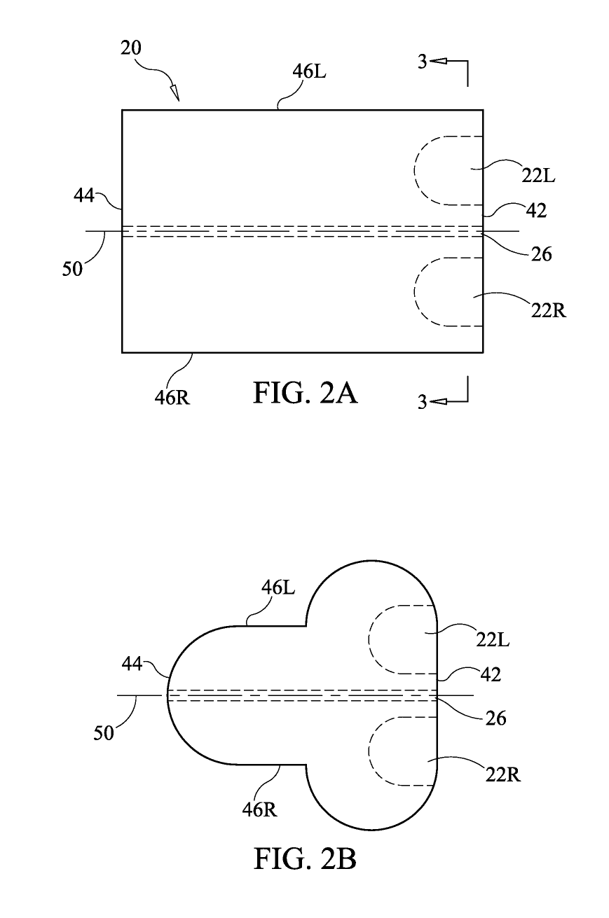

According to the preferred embodiment illustrated in FIG. 1, right side cutout 22R is generally U-shaped, with the base of the U extending inward from the cranial edge 42 of pad 20 such that the concave area of cutout 22R extends around the caudal aspect of shoulder area 14 to accommodate the protrusion on the horse's back created by the scapula and surrounding musculature. Only the right side of the horse and pad 20 is visible in FIG. 1, but pad 20 is symmetrical, as shown in FIG. 2, with the left side of pad 20 being the mirror image of the right side of pad 20.

FIGS. 2A and 2B show pad 20 shaped for a Western style saddle and a pad 20 shaped for an English style saddle, both laid flat, as on a table, viewed from above. Pad 20 is of a size and shape to extend over and beyond the area of interface of a load positioned on an animal's back. In a Western saddle embodiment (FIG. 2A), pad 20 demonstrates a generally rectangular shape. In an English saddle embodiment (FIG. 2B), the pad demonstrates an irregular shape, wherein the pad's caudal aspect is narrow relative to its cranial aspect. Pad 20 has a cranial edge 42, being the edge that extends closest to the horse's head, a caudal edge 44, being the edge that extends closest to the horse's tail, and two ventral edges, a right ventral edge 46R and left ventral edge 46L, being the edges that extend closest to the horse's belly when pad 20 is overlaid on the horse.

According to the embodiment of the present invention illustrated in FIG. 2A, constructed to accommodate a Western style saddle, the rectangular shape of pad 20 is completely circumscribed by cranial edge 42, caudal edge 44, and right and left ventral edges 46R and 46L. Perpendicular to cranial edge 42 and caudal edge 44, and bisecting pad 20 is a dorsal axis 50. Dorsal axis 50 runs parallel to right and left ventral edges 46R and 46L and overlays the horse's spine when pad 20 is in use.

Pad 20 is symmetrical along the dorsal axis 50, the right side being a mirror image of the left side. Illustrated by the broken lines in FIGS. 2A and 2B are left and right side cutouts 22L and 22R formed within the underside of saddle pads 20 and 20′. Left and ride side cutouts 22R and 22L are of identical in shape and size. Each demonstrates a semi-circular or U-shaped (with the U representing the void) form, with the base of the U extending inward from the pad's cranial edge 42 toward the pad's caudal edge 44 for a certain distance. Cutouts 22 are of suitable shape, dimension and position so as to overlay and encompass the entire shoulder area 14 of a horse and are positioned around the scapula and corresponding musculature of the horse's front legs.

Additional voids or cutouts may be made in pad 20 to accommodate other pressure points along the horse's back to address the downward pressure of the saddle and rider on the horse. According to a preferred embodiment, a further void in the shape of an elongated central channel 26 along dorsal axis 50 is formed in pad 20 to run atop and along the horse's spine and to reduce or relieve pressure on the spinal area.

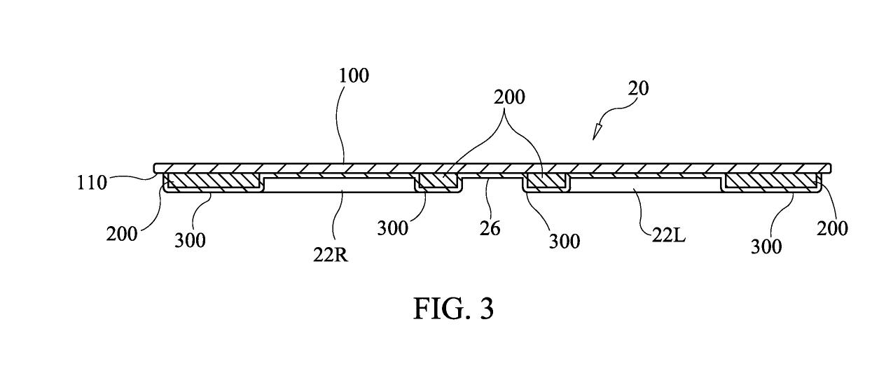

FIG. 3 illustrates the layered composition of a preferred embodiment of saddle pad 20 in cross-section. FIG. 3 is a cross section of saddle pad 20 taken along line 3-3 in FIG. 2A, through cutouts 22R and 22L and central channel 26, looking toward the rear of the horse.

Pad 20 of the present invention may be comprised of one or several layers. Referring to the preferred embodiment shown in FIG. 3, pad 20 comprises a top layer 100 that contacts the horse's saddle and a bottom layer 200, adhered to top layer 100, which contacts the horse. A liner 300 may, optionally, be adhered to the bottom side of bottom layer 200 to provide comfort to the horse by dissipating heat and wicking moisture away from the horse's body. Liner 300 preferably is molded and conforms to the recesses or voids in bottom layer 200 created by the cut-outs formed in or separation left between the left and right bottom side pieces.

The depth of the cutouts 22 may be equal to or less than the thickness of the pad 20. In a preferred embodiment, the thickness of saddle pads 20 is greater than the depth of cutouts 22, resulting in cutouts 22 that form a cavity or raised area on the underside of pad 20 but that do not go all the way through pad 20. This can be accomplished, as shown in FIG. 3, by having top layer 100 being continuous without cutouts, adhered to bottom layer 200 demonstrating cutouts 22 and 26 that extend clear through bottom layer 200.

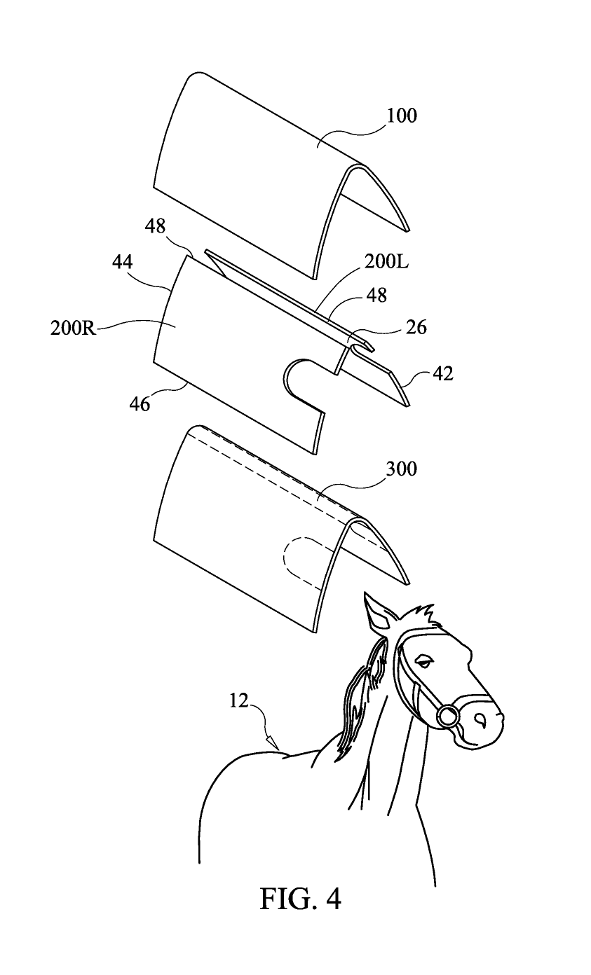

FIG. 4 illustrates an exploded view of the preferred embodiment wherein pad 20 is comprised of a top layer 100 and a bottom layer 200. As shown, bottom layer 200 is comprised of two separate pieces, a left side piece 200L and right side piece 200R, left side 200L and right side 200R being mirror images of one another. When pad 20 is placed on the horse, left side piece 200L of bottom layer 200 drapes over the left side of the horse's back 12 while right side piece 200R of bottom layer 200 drapes over the right side of back 12. In the Western saddle embodiment shown, each bottom layer side piece 200R and 200L are generally rectangular in shape and of a certain thickness, with cranial edge 42, caudal edge 44, ventral edge 46, and dorsal edge 48. In the English saddle embodiment, each bottom layer side piece 200R and 200L would demonstrate the irregular shape depicted in FIG. 2B with ventral edges 46R and 46L tapering rearward.

The relative positioning of the left and right side bottom layer pieces 200R and 200L is fixed by adhering each piece to top layer 100. Left and right side bottom layer pieces 200R and 200L, are adhered to top layer 100 in a parallel fashion, separated a certain distance one from the other to leave elongated narrow channel 26 that corresponds to and runs the length of the horse's spinal column along dorsal axis 50.

Referring to FIGS. 3 and 4, top layer 100 may be constructed of suitable hard-wearing fabric such as a high-quality felt, while bottom layer 200 may be constructed of suitable shock-absorbing material such as rubber. Bottom layer 200 may itself be comprised of one or more layers of shock-absorbing material. Lining 300, constructed of felt or other soft, breathable, or moisture-wicking material, may be adhered to the underside of bottom layer 200 to lie between the bottom layer and the horse's back when pad 20 is placing over horse's back 12.

Top layer 100 may be any thickness, but is typically ½ inches thick or between ¼ inches and ¾ inches in thickness. Bottom layer 200 may be any thickness, but is typically ¾ inches thick or between ½ inches and 1 inch in thickness. Liner 300 may be any thickness, but is typically ¼ inches thick or between 1/16 inches and ½ inches in thickness and typically thin relative to bottom layer 200.

The top layer 100, bottom layer 200, and lining 300 are adhered, one to the other, using suitable fastening means. The layers may be sewn together around their peripheral edges only, or both around their peripheral edges and internally. The layers may also be adhered together using glue or other adhesive means. In a preferred embodiment, the layers are both stitched and glued together for durability.

Layers 100 and 200, and lining 300 of saddle pad 20 have substantially matching peripheral edges. In a preferred embodiment, the layer 100 may extend beyond the periphery of bottom layer 200 so as to form a lip 110 (visible in FIG. 3) around the periphery of the underside of saddle pad 20. By using a high quality felt lining 300 molded to the underside of pad 20, breathability and moisture flow is permitted, so that less heat and moisture will build up beneath pad 20 while pad 20 in use on the horse.

As most clearly appreciated by considering FIGS. 3 and 4, right and left side cutouts 22R and 22L are formed along the cranial edge 42 of left and right side bottom layer pieces 200L and 200R, and extend completely through the thickness of the bottom layer 200. Central channel 26 is formed by the absence of bottom layer 200 material along dorsal axis 50 of saddle pad assembly 20. Dorsal axis 50 is positioned above and along the horse's spine when saddle pad 20 is placed upon the horse. At the position of cutouts 22 and central channel 26, portions of liner 300, as delineated by the dashed line on liner 300 in FIG. 4, are adhered directly to top layer 100 such that lining 300 is molded and conforms to the recesses or voids created by the absence of material in bottom layer 200.

Shoulder cutouts 22 are therefore ideally positioned to free the range of motion of the horse's forelimbs, allowing the full length of the forelimb and corresponding musculature to absorb shocks originating from the contact of the horse's forelimb with the ground. The clearance between the space occupied by the horse's shoulder and the edge of the voids created by cutouts 22 provide a free path for the shoulder's movement. Shock absorbing bottom layer 200 dissipates and reduces pressure on the horse's back while under saddle. Lining 300 readily conforms to the contours of the horse's back while keeping the horse cool.

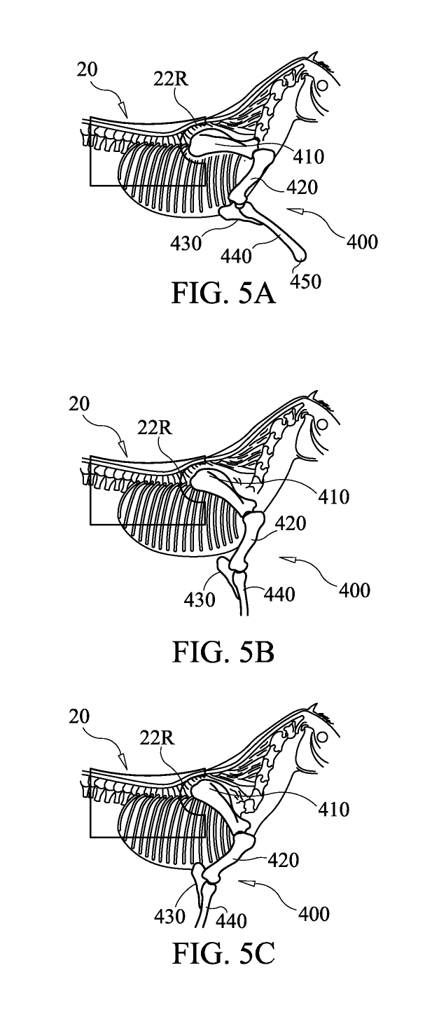

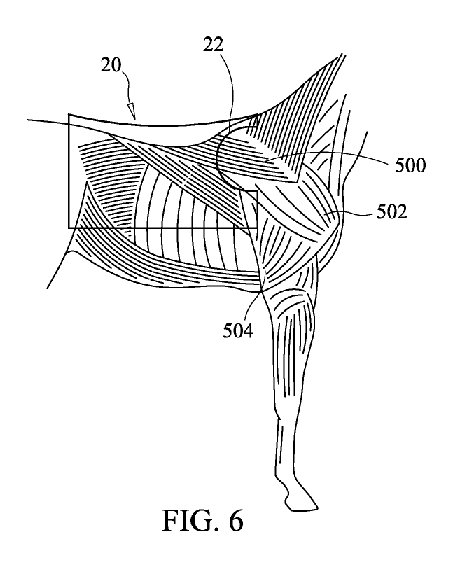

FIGS. 5A-5C illustrate skeletal views of a horse in motion from the horse's right side. FIG. 6 shows the musculature of the horse's forelimb, also from the right side.

The bones of a horse's right forelimb 400 include a scapula 410, a humerus 420, an ulna 430, a radius 440 and a knee 450. Forelimb 400's musculature includes a deltoid muscle 500, a biceps muscle 502, and a triceps muscle 504. Right shoulder cutout 22R of saddle pad assembly 20 is shown positioned around scapula 410 in FIG. 5 and around the corresponding musculature shown in FIG. 6, so as to accommodate the full range of motion of scapula 410 from the position where the forelimb is in a forward position (shown in FIG. 5A), a standing or neutral position (shown in FIG. 5B), or a rearward position (shown in FIG. 5C). The horse's deltoids 500, biceps 502 and triceps 504 (seen in FIG. 6) are similarly accommodated by the size and positioning of cutouts 22, allowing the horse under saddle full range of motion of its forelimbs throughout the full range of gaits.

The dimensions of pad 20 are selected based on the dimensions of the saddle so as to ensure that pad 20 will overlay and extend beyond the regions of the horse's back normally subject to contact and pressure from a saddle. The size and dimensions of cutouts 22 are selected such that the horse's shoulder blade region 14 will not be contacted or restricted by the saddle or by pad 20. The size and location of cutouts 22 within pad 20 may vary to allow full range of motion of the horse's joints and corresponding musculature. The degree of protrusion of a horse's shoulder blade is also considered. Additional cutouts may be formed to correspond to pressure points amenable to the downward force of a saddle, such as along the spine, above the withers, or at other positions on the horse's back. In the preferred embodiments illustrated here, the cutout areas are located above the horse's shoulder area and above the horse's spine.

### SUMMARY AND SCOPE

As will be appreciated from the above description, a defining feature of the present invention is the particularly positioned recesses, voids, cutouts, or raised aspects in the saddle pad positioned above and around the shoulder area of the horse to facilitate freedom of motion of the horse's shoulders by relieving restriction or pressure to the shoulder area caused by the constraints of the saddle and pad. The saddle pad lifts and supports the saddle and rider, but does not press upon or restrict movement of the horse's shoulder blade or surrounding musculature, allowing maximum range of mechanical movement of the horse's forelimbs, and permitting the saddled horse to take natural strides as if not under saddle or being ridden bareback.

Although the invention has been described with reference to specific embodiments, structures and configurations, this description is not meant to be construed in a limiting sense. Various modifications of the disclosed embodiments, as well as alternative embodiments of the inventions will become apparent to persons skilled in the art upon the reference to the description of the invention.

Cutouts 22 of the present invention are semi-circular or U-shaped and extend inward from the cranial edge of the saddle pad. Other embodiments, without limitation, may instead incorporate V-shaped, O-shaped, or irregularly shaped cutouts that may or may not extend to the cranial edge of the saddle pad.

Similarly, the shape and dimensions of the saddle pad may be varied to correspond to areas covered by different types or styles of saddles. The saddle pad of the instant invention may also be used on equines other than horses or on other load bearing or saddle animals, such as pachyderms or ungulates.

Also by way of example and not limitation, the improved saddle pad of the present invention may be constructed of one, two, three, or more than three layers; fabrics other than felt and shock absorbing materials other than rubber may be employed in these layers; and layer thicknesses other than those described above may be utilized, all without departing from the concept, spirit and scope of the instant invention. Wear pieces may be adhered to the top of the improved saddle pad to slow wear caused by the topside of the pad rubbing against the underside or skirts of the saddle. Similarly other structures and techniques known to those conversant in the prior art as employed with saddles and saddle pads may be employed with the improved saddle pad described above, to the extent not incompatible with or detracting from the utility of said pad, while still remaining within the purpose and scope of the present invention.

Accordingly, while the embodiments of the invention disclosed herein are presently considered to be preferred, various changes and modifications can be made without departing from the spirit and scope of the invention. The scope of the invention should be determined by the appended claims and their legal equivalents, rather than with reference to any particular example, embodiment or illustration.

What is claimed is:

1. A saddle pad to cushion and distribute a load placed on a horse's back that facilitates unrestricted movement of the horse's forelimbs when the horse is in motion, comprising a pad having a shape and area to underlay the interface of said load on said horse's back and having voids formed within said pad that correspond to and overlay the horse's shoulder blade area.

2. The saddle pad of claim 1, further comprising a raised area on the underside of said pad running substantially from front to back down the center of said pad to overlay and relieve pressure to the horse's spine.

3. The saddle pad of claim 1, wherein said voids are generally U-shaped, oriented with the base of said U extending inward from said pad's cranial edge, with the concave area of said U sized to accommodate an area above and around the horse's shoulder blades.

4. The saddle pad of claim 1, wherein said saddle pad is comprised of a top layer and bottom layer and said voids are formed by cutouts made in the bottom layer.

5. The saddle pad of claim 1, wherein said voids are raised areas in the underside of said saddle pad such that the depth of said voids is less than the thickness of said pad.

6. The saddle pad of claim 2, wherein said saddle pad is comprised of a top layer and a bottom layer, the bottom layer is comprised of left and right side pieces, said elongated void above the horse's spine is formed by a separation of a width between said left and right side pieces, and said voids above the horse's shoulder blades are formed by semi-circular cut-outs extending inward, in concave fashion, from the front edges of the left and right side pieces.

7. The saddle pad of claim 6 wherein the top layer is fabricated from breathable fabric.

8. The saddle pad of claim 6, wherein the bottom layer is fabricated from shock absorbing material.

9. The saddle pad of claim 7, wherein the breathable fabric is felt.

10. The saddle pad of claim 8, wherein the shock absorbing material is a synthetic having properties of durability, resistance to deformation, shock absorbency and resilience.

11. The saddle pad of claim 8, wherein the shock absorbing material is one or more layers of rubber.

12. The saddle pad of claim 6, further comprising an additional layer of breathable fabric material adhered and conformed to the shape of the underside of bottom layer of shock absorbing material for comfort to the horse.

13. The saddle pad of claim 12, wherein the further layer of fabric material adhered and conformed to the underside of the shock absorbing material is felt.

14. The saddle pad of claim 6, further comprising a wear piece adhered to the topside of the top breathable fabric material to slow chafing wear from the saddle.

15. The saddle pad of claim 14, wherein the wear piece is fabricated from leather.

16. A saddle pad designed to be placed between the saddle and a horse's back that allows unrestricted movement of the horse's forelimbs when the horse is in motion comprising a top layer and a bottom layer, wherein said bottom layer exhibits cutouts that overlay and accommodate the horse's shoulder blade area.

17. The saddle pad of claim 16, further comprising a channel running front to back down the middle of said bottom layer that overlays and relieves pressure to the horse's spine.

18. The saddle pad of claim 16, wherein said cutouts are semi-circular in shape extending inward, in concave fashion, from said pad's forward edge, sized to accommodate an area above and around the horse's shoulder blades.

19. The saddle pad of claim 16, wherein said top layer is fabricated from breathable fabric and said bottom layer is fabricated from shock absorbing material.

20. The saddle pad of claim 16, wherein said pad is generally rectangular in shape for use with a Western style saddle.

21. The saddle pad of claim 16, wherein said pad's rear aspect is narrow relative to its forward aspect for use with an English style saddle.
